(19) United States
(12) Patent Application Publication
(10) Pub. No.: US 2014/0219868 A1
(43) Pub. Date: Aug. 7, 2014

(54) REACTION APPARATUS, CONTROL DEVICE, AND CONTROL PROGRAM

(71) Applicant: HORIBA STEC, CO., LTD., Kyoto (JP)

(72) Inventors: Tomohiro SASAKI, Kyoto (JP); Shoji NARUKAMI, Kyoto (JP); Tsuneaki MAEDA, Kyoto (JP)

(73) Assignee: HORIBA STEC, CO., LTD., Kyoto (JP)

(21) Appl. No.: 14/169,666

(22) Filed: Jan. 31, 2014

(30) Foreign Application Priority Data
Feb. 4, 2013 (JP) 2013-019590
Feb. 4, 2013 (JP) 2013-019591

(51) Int. Cl. G01N 27/62

(52) U.S. Cl. CPC G01N 27/626
USPC 422/54; 422/83; 702/22

(57) ABSTRACT

The present invention is mainly intended to provide a reaction apparatus that can prevent a problem due to heat generated by heat treatment in a reaction part, and accurately perform detection, and the reaction apparatus is provided with: a reaction part that is introduced with sample gas having passed through a column and reaction gas, and as a result of a reaction between the sample gas and the reaction gas, produces measurement gas containing a predetermined compound; a protruding pipe that is integrally protruded from the reaction part; and a connecting part that is disposed separately from the reaction part and removably fitted with the protruding pipe.

### TECHNICAL FIELD

The present invention relates to a reaction apparatus that is used to detect a sample such as a hydrocarbon compound.

Also, the present invention relates to a control device and a control program that are used to detect the sample.

### BACKGROUND ART

As an apparatus used to analyze a sample such as a hydrocarbon compound, for example, there is a gas chromatograph described in Patent Literature 1.

The gas chromatograph is provided with: an oxidation reaction part in which a sample introduced through a column and reaction gas are heat-treated and thereby converted into carbon monoxide; a reduction reaction part in which the carbon monoxide produced in the oxidation reaction part and reaction gas are heat-treated and thereby converted into methane as a predetermined compound; and a hydrogen flame ionization detector that detects the methane as the predetermined compound.

Also, as an apparatus used to analyze a sample such as a hydrocarbon compound, for example, there is a gas chromatograph described in Patent Literature 2.

This gas chromatograph is provided with: a column; and a detector that uses, for example, a hydrogen flame ionization detector (FID) or the like, to detect a sample having passed through the column.

### CITATION LIST

### Patent Literature

Patent Literature 1: JPA2010-216850
Patent Literature 2: JPA2001-194356

### SUMMARY OF INVENTION

### Technical Problem

Meanwhile, in the gas chromatograph as described in Patent Literature 1, the column is arranged in a thermostatic chamber to keep a constant temperature, and also the thermostatic chamber and the oxidation reaction part are connected to each other through a pipe. In addition, in order to replace a metal catalyst in the oxidation reaction part, a connecting part between the oxidation reaction part and the pipe is provided with a joint that is provided close to the oxidation reaction part and also enables the oxidation reaction part to be removed from the pipe.

For this reason, there occurs a problem that heat generated by the heat treatment in the oxidation reaction part also transfers to the joint to burn the joint, and therefore the metal catalyst in the oxidation reaction part is not easily replaced.

As one of methods for solving the problem, for example, there is a possible method that expands an inside diameter of the oxidation reaction part to prevent the heat from transferring to the joint; however, expanding the inside diameter of the oxidation reaction part causes an inside diameter of the pipe connected to the oxidation reaction part to be also expanded. Meanwhile, it is known that a flow velocity of fluid flowing through a pipe is inversely proportional to a pipe diameter, and expanding the pipe diameter of the pipe causes a flow velocity of the reaction gas passing through the pipe to be decreased. For this reason, there occurs a new problem that the sample mixed with the reaction gas diffuses in the oxidation reaction part, or flows back to the column from the oxidation reaction part, and thereby a variation in time for the methane as the predetermined compound to arrive at the detector occurs, which makes a width of a detected peak broad.

Also, the detector used for the gas chromatograph as described in Patent Literature 2 is one that ionizes the sample with combustion flame, and uses current generated by the ion to detect the sample.

For this reason, in the case where due to a manufacturing variation in inside diameter, length, or the like of the column, an error occurs in a calculated value of a carrier gas flow rate, or due to temperature inside the column, the carrier gas flow rate is varied, a flow rate of the sample introduced into the detector is varied to change a shape of the combustion flame. The change in shape of the combustion flame varies a rate of the ionization produced around the combustion flame and changes measurement sensitivity of the detector, and therefore there occurs a problem of being unable to perform accurate detection.

The present invention is made in order to solve the above-described problems, and a main object thereof is to provide a reaction apparatus that can prevent the heat problem occurring due to the heat treatment and accurately perform detection.

Also, the present invention is intended to provide a control device and control program that can perform accurate measurement by making constant a flow rate of gas introduced into a detector.

### Solution to Problem

The reaction apparatus of the present invention is provided with: a reaction part that is introduced with sample gas having passed through a column and reaction gas, and as a result of a reaction between the sample gas and the reaction gas, produces measurement gas containing a predetermined compound; a protruding pipe that is integrally protruded from the reaction part; and a connecting part that is disposed separately from the reaction part and removably fitted with the protruding pipe.

With this configuration, the protruding pipe is integrally protruded from the reaction part, so that it is not necessary to separately provide a connecting member such as a joint in a connecting part between the reaction part and the protruding pipe, and a problem of burning the connecting member due to heat generated by heat treatment in the reaction part, and other problems can be avoided. Also, the connecting part removably fitted with the protruding pipe is disposed separately from the reaction part, so that the heat generated in the reaction part is unlikely to transfer to the connecting part, and therefore a problem due to the heat can be prevented from occurring in the connecting part.

In the reaction apparatus of the present invention, preferably, the connecting part is provided with a supply path for supplying the reaction gas; the reaction part has a reaction pipe having one end surface from which the protruding pipe integrally protrudes; and an inside diameter of the protruding pipe is equal to or less than an inside diameter of the reaction pipe.

With this configuration, the reaction gas is supplied to the connecting part arranged on an upstream side of the protruding pipe, and therefore by setting the inside diameter of the protruding pipe small as compared with the inside diameter of the reaction pipe, a flow velocity of the reaction gas passing through the protruding pipe can be increased to prevent the sample gas mixed with the reaction gas in the reaction pipe from diffusing or flowing back, and therefore accurate detection can be performed.

In addition, only by making the reaction gas pass through the protruding pipe, the flow velocity of the reaction gas can be increased, so that it is not necessary to separately provide a pipe to flow another gas for increasing the flow velocity, and therefore an apparatus configuration of the reaction apparatus can be simplified.

In the reaction apparatus of the present invention, preferably, the column extending to the reaction pipe passes through the protruding pipe; the reaction gas passes through a gap between the column and the protruding pipe; and the sample gas having passed through the column and the reaction gas are mixed in the reaction pipe.

With this configuration, only in the reaction pipe, the sample gas and the reaction gas are mixed, and therefore the sample gas can be preferably prevented from diffusing or flowing back.

Preferably, the reaction apparatus of the present invention is further provided with a thermostatic chamber of which an inside is arranged with the column and the connecting part and a surface is formed with a through-hole, wherein the protruding pipe is inserted into the thermostatic chamber through the through-hole, and the reaction part is placed on the surface of the thermostatic chamber.

With this configuration, the protruding pipe is inserted into the thermostatic chamber through the through-hole, and the reaction part is placed on the surface of the thermostatic chamber to make the column hardly extend from the thermostatic chamber, so that a problem such as midstream liquefaction of the sample passing through the column can be prevented to stably perform measurement with accuracy.

In the reaction apparatus of the present invention, preferably, the connecting part is a three-way joint that is provided with a first joint, a second joint, and a third joint disposed between the first joint and the second joint; and the column passes through the first joint and the second joint, the second joint arranged on a downstream side of the column is removably fitted with the protruding pipe, and the third joint is fitted with the supply path.

With this configuration, the third joint is provided with the supply path for supplying the reaction gas, so that it is not necessary to separately provide the protruding pipe with a branch path or the like for supplying the reaction gas, and therefore only by removing the protruding pipe from the second joint, maintenance such as replacing a catalyst in the reaction part can be simply performed.

Also, the control device of the present invention is provided with: a reaction part that is introduced with sample gas having passed through a column and reaction gas of which a flow rate is regulated by a flow rate regulating valve, and as a result of a reaction between the sample gas and the reaction gas, produces measurement gas containing a predetermined compound; a flowmeter that is provided on a downstream side of the reaction part and measures a flow rate of the measurement gas to be introduced into a detector for detecting the predetermined compound; and a control part that controls the flow rate regulating valve such that the flow rate of the measurement gas, which is measured by the flowmeter, becomes a predetermined value.

With this configuration, by controlling the flow rate of the reaction gas to keep the flow rate of the measurement gas, which is to be introduced into the detector, constant at the predetermined value, a variation in measurement sensitivity of the detector, which occurs in association with a change in shape of combustion flame, can be prevented to perform accurate detection.

Also, by keeping the flow rate of the measurement gas constant at the predetermined value with use of the reaction gas used to produce the measurement gas, it is not necessary to separately provide a pipe or the like only for the purpose of making the flow rate of the measurement gas constant, and the flow rate of the measurement gas can be made constant with cost being suppressed.

In the control device of the present invention, preferably, the control part performs arithmetic processing on a deviation between a measured flow rate value of the measurement gas, which is measured by the flowmeter, and a predetermined target flow rate value to generate a drive signal, and uses the drive signal to control the flow rate regulating valve.

Also, in the control device of the present invention, preferably, the reaction part is provided with a metal catalyst.

In the case where the reaction part is provided with a metal catalyst in order to facilitate the reaction, depending on a sample amount, heating temperature in the reaction part may be elevated to make the metal catalyst give rise to thermal expansion, and a pressure loss may be changed to vary the flow rate of the measurement gas. However, in the control device of the present invention, the flow rate of the measurement gas, which is varied by the thermal expansion of the metal catalyst, is measured by the flowmeter, and the control part uses the measured flow rate value to generate the drive signal, and inputs the drive signal to flow rate regulating valve, so that the reaction gas can be controlled in accordance with the flow rate of the measurement gas, which is varied by the thermal expansion, and even in the case where the metal catalyst is thermally expanded, accurate detection can be performed.

In the control device of the present invention, preferably, the reaction part has an oxidation reaction part that is introduced with the sample gas and air of which a flow rate is regulated by a first flow rate regulating valve, and mixes the sample gas and the air to produce oxidation gas as a result of an oxidation reaction, and a reduction reaction part that is introduced with the oxidation gas and hydrogen gas of which a flow rate is regulated by a second flow rate regulating valve, and as a result of a reduction reaction between the oxidation gas and the hydrogen gas, produces the measurement gas containing the predetermined compound; the flowmeter is provided on a downstream side of the reduction reaction part; and the control part uses the drive signal to control the second flow rate regulating valve.

With this configuration, in the reduction reaction part provided immediately before the measurement by the flowmeter, the flow rate of the hydrogen gas is controlled to make the flow rate of the measurement gas constant, so that the flow rate of the measurement gas can be more accurately made constant, and therefore accurate detection can be performed.

In the control device of the present invention, preferably, the detector is a hydrogen flame ionization detector.

### Advantageous Effects of Invention

According to the present invention, the heat problem occurring due to the heat treatment can be prevented, and the detection can be accurately performed.

Also, according to the present invention, the flow rate of the measurement gas can be made constant to prevent a rate of ionization produced around the combustion flam from being varied, and therefore without changing the measurement sensitivity of the detector, accurate measurement can be performed.

### BRIEF DESCRIPTION OF DRAWINGS

FIG. 1 is an outline view representing a reaction apparatus of a first embodiment of the present invention;

FIG. 2 is a cross-sectional view in which a connecting part and a protruding pipe in the reaction apparatus of the first embodiment of the present invention are enlarged;

FIG. 3 a cross-sectional view in which a connecting part and a protruding pipe in a reaction apparatus of a second embodiment of the present invention are enlarged;

FIG. 4 is a cross-sectional view in which a connecting part and a protruding pipe in a reaction apparatus of a third embodiment of the present invention are enlarged;

FIG. 5 is a schematic diagram representing a control device of a fourth embodiment of the present invention; and

FIG. 6 is an outline view representing control by the control device of the fourth embodiment of the present invention.

### DESCRIPTION OF EMBODIMENTS

A first embodiment of a reaction apparatus of the present invention is described below with reference to drawings.

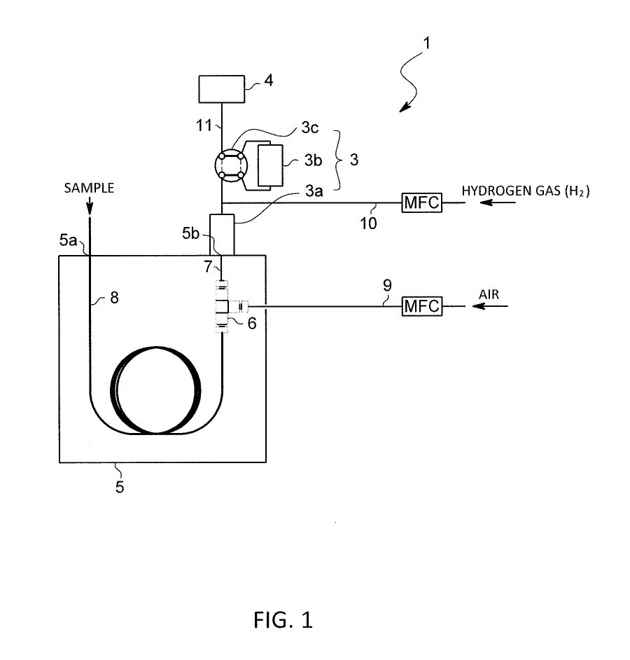

A reaction apparatus 1 of the first embodiment is, as illustrated in FIG. 1, provided with: a thermostatic chamber 5 that contains a column 8 inside; a reaction part 3 that is connected to the thermostatic chamber 5, introduced with sample gas having passed through the column 8 and reaction gas, and produces measurement gas containing a predetermined compound as a result of a heat reaction between the sample gas and the reaction gas; a protruding pipe 7 that integrally protrudes from the reaction part 3; a connecting part 6 that is disposed separately from the reaction part 3, and removably fitted with the protruding pipe 7; and a detector 4 that detects the predetermined compound contained in the measurement gas led out from the reaction part 3.

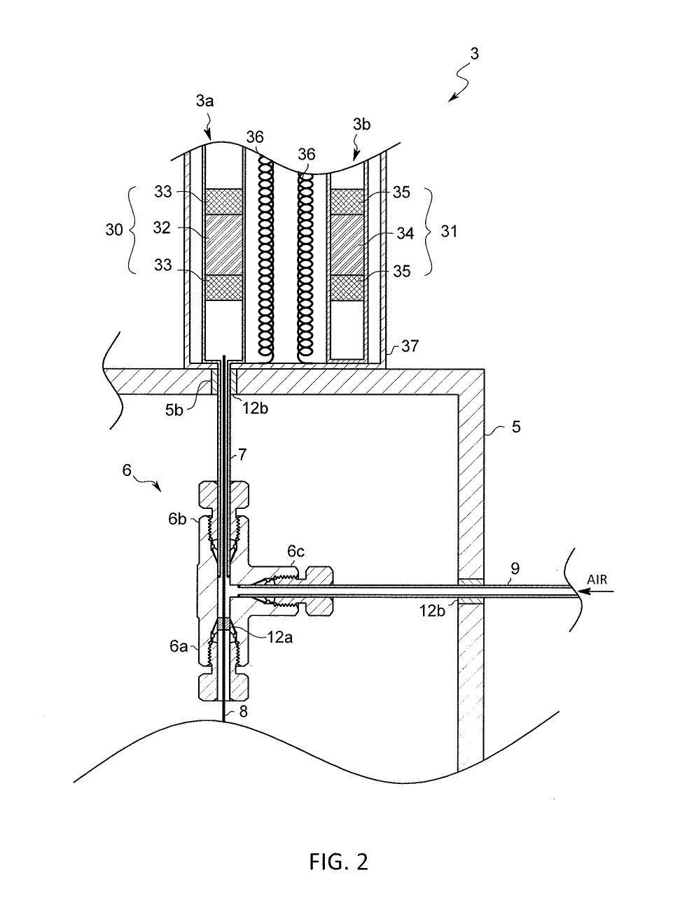

The thermostatic chamber 5 is a housing provided with an unillustrated heater, inlet/outlet ports, cooling fan, and the like for keeping temperature inside the chamber at a constant temperature suitable for the measurement sample, and as illustrated in FIGS. 1 and 2, in a surface thereof, provided with: a sample introduction port 5a from which the measurement gas and carrier gas are introduced; and a sample lead-out port 5b into which a fore end of the protruding pipe 7 is inserted.

The sample introduction port 5a is a through-hole provided in the surface of the thermostatic chamber 5, and the through-hole is inserted with an unillustrated syringe that is connected to one end of the column 8 arranged in the thermostatic chamber 5. The through-hole is filled with a heat insulating material 12b such as glass wool except for a part where the syringe is inserted.

The sample lead-out port 5b is a through-hole provided in the surface of the thermostatic chamber 5, and the through-hole is inserted with the protruding pipe 7. The through-hole is filled with a heat insulating material 12b such as glass wool except for a part where the protruding pipe 7 is inserted.

The column 8 is a long-sized object that has a diameter of a few hundred micrometers to a few millimeters and is annularly shaped in a cross-sectional view, and as the column 8, a capillary column of which an inner wall is coated with a stationary phase can be used. As the stationary phase, a publicly known phase can be appropriately used depending on the type of a sample.

Also, the upstream side one end of the column 8 is connected to the syringe inserted into the sample introduction port 5a of the thermostatic chamber 5, and the downstream side other end passes through a first joint 6a and second joint 6b of the connecting part 6, and the protruding pipe 7, and extends to an after-mentioned oxidation reaction pipe 30.

Further, the connecting part 6 is made of a metal member such as SUS316 arranged in the thermostatic chamber 5, and a three-way joint of which the first joint 6a, second joint 6b, and third joint 6c disposed between the first joint 6a and the second joint 6b form a T-shape. Also, the column 8 passes through the mutually opposite first and second joints 6a and 6b among the three joints 6a, 6b, and 6c, and inside the first joint 6a arranged on the upstream side of the column 8, a gap between the column 8 and the first joint 6a is sealed with a sealing member 12a such as a graphite ferrule, whereas the second joint 6b arranged on the downstream side of the column 8 is removably fitted with the protruding pipe 7. The third joint 6c is fitted with a first supply path 9 for supplying air to the after-mentioned oxidation reaction pipe 30.

In addition, mechanisms for the above-described fitting include, for example, a mechanism that, in a state where the fore end of the protruding pipe 7 is inserted into the second joint 6b, rotates a nut part to tighten the protruding pipe 7, and fits the protruding pipe 7 to the second joint 6b. Also as a mechanism for fitting the first supply path 9 to the third joint 6c, the same mechanism can be cited.

The first supply path 9 is one that sends air supplied from an air cylinder to the connecting part 6 through a mass flow controller or the like as a flow rate control device with one end thereof being fitted to the air cylinder and the other end thereof being fitted to the third joint 6c of the connecting part 6 arranged in the thermostatic chamber 5. Also, the downstream side end of the first supply path 9 is inserted into a through-hole provided in the thermostatic chamber 5, and the through-hole is filled with a heat insulating material 12b such as glass wool except for a part where the first supply path 9 is inserted. In addition, a mechanism for fitting the first supply path 9 and the third joint 6c of the connecting part 6 to each other has also the same configuration described above, and therefore description thereof is omitted.

As the mass flow controller, for example, a thermal type one that controls a flow rate of fluid on the basis of a temperature difference that is generated between two pairs of heating resistance wires by flowing the fluid through the first supply path 9 in a state where the two pairs of heating resistance wires are wound around the first supply path 9 to form a bridge circuit and current is flowed through the heating resistance wires to heat the heating resistance wires can be used.

The protruding pipe 7 is provided by machining such as welding, or the like, so as to integrally protrude from an upstream side end surface of the after-mentioned oxidation reaction pipe 30. Also, the protruding pipe 7 is arranged with being inserted into the thermostatic chamber 5 from the sample lead-out port 5b, and the fore end thereof is removably fitted to the second joint 6b of the connecting part 6.

Also, in the present embodiment, an inside diameter ( 1/16 inches) of the protruding pipe 7 is smaller than an inside diameter (⅛ inches) of the after-mentioned oxidation reaction pipe 30. Inside the protruding pipe 7, the column 8 extending from the second joint 6b of the connecting part 6 is inserted.

The reaction part 3 is provided with: an oxidation reaction part 3a that is connected to the thermostatic chamber 5 through the protruding pipe 7; a reduction reaction part 3b that is connected to the oxidation reaction part 3a through a four-way valve 3c; heaters 36 that are arranged near the oxidation reaction part 3a and the reduction reaction part 3b, and heat the oxidation reaction part 3a and the reduction reaction part 3b, respectively; and a casing 37 that contains the oxidation reaction part 3a, reduction reaction part 3b, and heaters 36.

The oxidation reaction part 3a is, as illustrated in FIG. 2, provided with the oxidation reaction pipe 30 inside which a metal catalyst 32 such as palladium is filled, around which a heat insulating material 33 such as glass wool is filled. Near the oxidation reaction pipe 30, the heater 36 for heating the oxidation reaction pipe 30 is arranged. Further, the protruding pipe 7 is provided by welding or the like so as to continuously and integrally protrude from the upstream side end surface of the oxidation reaction pipe 30, and a downstream side end of the oxidation reaction pipe 30 is connected to the four-way valve 3c.

The reduction reaction part 3b is provided with a reduction reaction pipe 31 connected to the four-way valve 3c, inside which a metal catalyst 34 such as nickel is filled, around which a heat insulating material 35 is filled. Near the reduction reaction pipe 31, the heater 36 for heating the reduction reaction pipe 31 is arranged. In addition, in the present embodiment, the reduction reaction part 3b is placed on the surface of the thermostatic chamber 5 in parallel with the oxidation reaction part 3a.

In the four-way valve 3c, for example, the oxidation reaction pipe 30, the reduction reaction pipe 31, a second supply path 10 for supplying hydrogen gas as reaction gas to the reduction reaction pipe 31, and a measurement pipe 11 fitted to the detector 4 are fitted to unillustrated flow path holes corresponding to the respective flow paths, and the four-way valve 3c is provided with: unillustrated valve elements that are arranged on the flow path holes to open/close the flow paths; unillustrated annularly shaped coils that are arranged in upper parts of the valve elements; fixed cores that are arranged in the annularly shaped coils; movable cores that are arranged between the fixed cores and the valve elements and connected to the valve elements, respectively, and the like.

The four-way valve 3c is one that opens/closes each of the flow paths in such a way that when current flows through a corresponding one of the coils, a corresponding fixed core and movable core are magnetized and mutually attracted, and thereby the movable core moves a corresponding valve element. In addition, as a mechanism for the movable core to move the valve element, a direct acting type that mechanically moves the valve element may be used, or a pilot type that uses a pressure difference of fluid to move the valve element may be used.

The second supply path 10 is one that sends the hydrogen gas sent from a hydrogen cylinder to the four-way valve 3c through a mass flow controller with an upstream side end being connected to the hydrogen cylinder and the downstream side other end being connected to the four-way valve 3c. Note that the structure of the mass flow controller has the same configuration as that described in paragraph [0031], and therefore description thereof is omitted here.

The casing 37 is a casing that contains the oxidation reaction part 3a, reduction reaction part 3b, and heater 36 inside, of which one side is provided with a hole part, and the casing 37 is arranged on the thermostatic chamber 5 such that the hole part and the sample lead-out port 5b of the thermostatic chamber 5 overlap.

Further, the protruding pipe 7 passes through the sample lead-out port 5b from the hole part of the casing 37 and is inserted into the thermostatic chamber 5, and therefore the upstream side end surface of the oxidation reaction pipe 30 is, through the casing 37, placed on the surface of the thermostatic chamber 5, where the sample lead-out port 5b is provided.

The detector 4 is a detector such as a hydrogen flame ionization detector (FID) that detects the predetermined compound by measuring ionization current that is generated by flowing the measurement gas into hydrogen flame, which is combustion flame, to ionize the measurement gas with the hydrogen flame.

Operation of the reaction apparatus 1 of the present embodiment is described below.

When the measurement sample mixed in the carrier gas is injected into the column 8 by the syringe inserted into the sample introduction port 5a, the sample gas that has taken a passage time depending on the molecular weight of the measurement sample, or the like, to pass through the column 8 is led out to the oxidation reaction pipe 30. In addition, as the carrier gas, for example, inert gas such as helium or argon, hydrogen gas, air, oxygen gas, or the like can be used.

Also, the air as the reaction gas, which is introduced from the air cylinder through the mass flow controller, is also led out to the oxidation reaction pipe 30 from the first supply path 9 with passing through the third joint 6c, and second joint 6b of the connecting part 6, and the protruding pipe 7 in this order.

In addition, in the thermostatic chamber 5 containing the column 8, temperature is appropriately regulated correspondingly to the measurement sample such that the measurement sample keeps a gasified state. Also, in the case where the measurement sample is gas, the measurement sample is directly injected into the column 8; however, in the case where the measurement sample is liquid, the measurement sample is heated and vaporized in an unillustrated vaporizing chamber, and then injected into the column 8.

The sample gas and air introduced into the oxidation reaction pipe 30 are mixed in the oxidation reaction pipe 30, and also the oxidation reaction pipe 30 is heated by the heater 36 to thereby produce an oxidation reaction and consequently produce oxidation gas containing carbon dioxide.

The oxidation gas produced in the oxidation reaction pipe 30 is led out to the reduction reaction pipe 31 from the flow path hole of the four-way valve 3c, which is connected to the oxidation reaction pipe 30, through the flow path hole connected to the reduction reaction pipe 31. Also, the hydrogen gas as the reaction gas, which is introduced from the hydrogen cylinder through the mass flow controller, is also lead out to the reduction reaction pipe 31 from the flow path hole of the four-way valve 3c, which is connected to the second supply path 10, through the flow path hole connected to the reduction reaction pipe 31. In addition, the four-way valve 3c is appropriately opened/closed in accordance with the respective operations.

The oxidation gas and hydrogen gas introduced into the reduction reaction pipe 31 are mixed in the reduction reaction pipe 31, and the reduction reaction pipe 31 is heated by the heater 36 to thereby produce a reduction reaction and consequently produce the measurement gas containing methane that is the predetermined compound.

The measurement gas produced in the reduction reaction pipe 31 is introduced into the detector 4 from the flow path hole of the four-way valve 3c, which is connected to the reduction reaction pipe 31, through the flow path hole connected to the measurement pipe 11.

The measurement gas introduced into the detector 4 is ionized with the hydrogen flame of the detector 4, and by measuring the ionization current generated by the ion, the methane as the predetermined compound contained in the measurement gas is detected.

In addition, as necessary, a filter for capturing and removing water produced by the oxidation reaction or the reduction reaction may be provided near the four-way valve 3c.

According to the present invention, the protruding pipe 7 is integrally protruded from the upstream side end surface of the oxidation reaction pipe 30, so that it is not necessary to separately provide a connecting member such as a joint in a connecting part between the oxidation reaction pipe 30 and the protruding pipe 7, and therefore a problem of burning the connecting member due to heat generated in the reaction part 3 by the heat treatment of the oxidation reaction pipe 30, and other problems can be avoided. Also, the second joint 6b of the connecting part 6, which is removably fitted with the protruding pipe 7, is disposed separately from the reaction part 3, so that the heat generated in the reaction part 3 is unlikely to transfer to the connecting part 6, and therefore a heat problem can be prevented from occurring in the connecting part 6.

Further, according to the present invention, the connecting part 6 arranged on an upstream side of the protruding pipe 7 is supplied with the reaction gas, so that by as compared with the inside diameter of the oxidation reaction pipe 30, forming the inside diameter of the protruding pipe 7 to be smaller, a flow velocity of the reaction gas passing through the protruding pipe 7 can be made more higher to prevent the sample gas mixed with the reaction gas in the oxidation reaction pipe 30 from diffusing or flowing back, and therefore accurate detection can be performed.

In addition, only by making the reaction gas pass through the protruding pipe 7, the flow velocity of the reaction gas can be increased, so that it is not necessary to separately provide a pipe to flow another gas for increasing the flow velocity, and therefore an apparatus configuration of the reaction apparatus 1 can be simplified.

According to the present invention, the third joint 6c of the connecting part 6 is fitted with the first supply path 9 for supplying the reaction gas, so that it is not necessary to separately provide the protruding pipe 7 with a branch path for supplying the reaction gas, and only by removing the protruding pipe 7 from the second joint 6b of the connecting part 6, maintenance such as replacing the metal catalyst 31 in the oxidation reaction pipe 30 can be simply performed.

According to the present invention, the column 8 extending to the oxidation reaction pipe 30 passes through the protruding pipe 7, and the reaction gas passes through a gap between the column 8 and the protruding pipe 7 and is mixed with the sample gas only in the oxidation reaction pipe 30, so that the sample gas can be preferably prevented from diffusing or flowing back.

According to the present invention, the protruding pipe 7 is inserted into the thermostatic chamber 5 from the hole part of the casing 37 through the sample lead-out port 5b, and thereby the upstream side end surface of the oxidation reaction pipe 30 is, through the casing 37, placed on the surface of the thermostatic chamber 5, where the sample lead-out port 5b is provided, so that the column 8 hardly extends from the thermostatic chamber 5 to prevent a problem such as midstream liquefaction of the sample passing through the column 8, and therefore measurement can be stably performed with accuracy.

Next, a second embodiment of the reaction apparatus in the present invention is described below with reference to drawings.

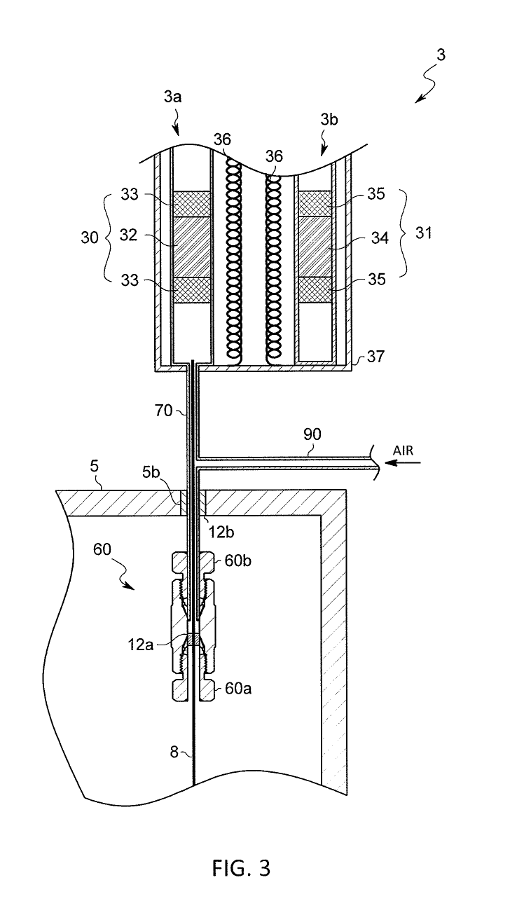

A reaction apparatus in the second embodiment is, as illustrated in FIG. 3, a variation of the above-described reaction apparatus in the first embodiment, and different mainly in configurations of a connecting part 60 and protruding pipe 70; however, parts other than matters described below are the same as those in the first embodiment, and therefore description thereof is omitted.

The connecting part 60 is a joint that is arranged in the thermostatic chamber 5 and has an I-shape. Also, inside mutually opposite first and second joints 60a and 60b, the column 8 penetrates, and the inside of the first joint 60a arranged on the upstream side of the column 8 is sealed with a sealing member 12a such as a graphite ferrule so as to surround the column 8, whereas the second joint 60b arranged on the downstream side of the column 8 is removably fitted with the protruding pipe 70.

The protruding pipe 70 is provided by machining such as welding, or the like, so as to integrally protrude from the upstream side end surface of the oxidation reaction pipe 30, and a fore end thereof is inserted into the sample lead-out port 5b of the thermostatic chamber 5 and removably fitted to the second joint 60b of the connecting part 60 arranged in the thermostatic chamber 5.

Note that the oxidation reaction pipe 30 is contained in the casing 37 together with the reduction reaction pipe 31 and the heaters 36, the casing 37 is disposed separately from the thermostatic chamber 5, and the oxidation reaction pipe 30 and the thermostatic chamber 5 are connected to each other through the protruding pipe 70.

For this reason, regarding the protruding pipe 70, the fore end part is arranged inside the thermostatic chamber 5, and a part integrally protruding from the oxidation reaction pipe 30 is arranged outside the thermostatic chamber 5.

Also, the protruding pipe 70 arranged outside the thermostatic chamber 5 is provided with a branch path, and the branch path serves as a first supply path 90 for supplying air as reaction gas to the oxidation reaction pipe 30. In addition, the first supply path 90 is formed by machining such as welding so as to be continuously integrated with the protruding pipe 70.

Even in the second embodiment, the oxidation reaction pipe 30 and the second joint 60b of the connecting part 60 are separately disposed, and therefore a problem that heat generated by heat treatment of the oxidation reaction pipe 30 adversely influences the second joint 60b can be prevented. Also, the first supply path 90 provided on the protruding pipe 70 is provided integrally with the protruding pipe 70 without a joint or the like, and therefore even in the first supply path 90, a heat problem caused by a heat reaction can be avoided.

Further, an inside diameter of the protruding pipe 70 is small as compared with the inside diameter of the oxidation reaction pipe 30, and the first supply path 90 is provided at the middle of the protruding pipe 70, so that the air supplied from the first supply path 90 can prevent the sample gas mixed with the air in the oxidation reaction pipe 30 from diffusing or flowing back because a flow velocity is increased while the air is passing through the protruding pipe 70, and therefore accurate detection can be performed.

Next, a third embodiment of the reaction apparatus in the present invention is described below with reference to drawings.

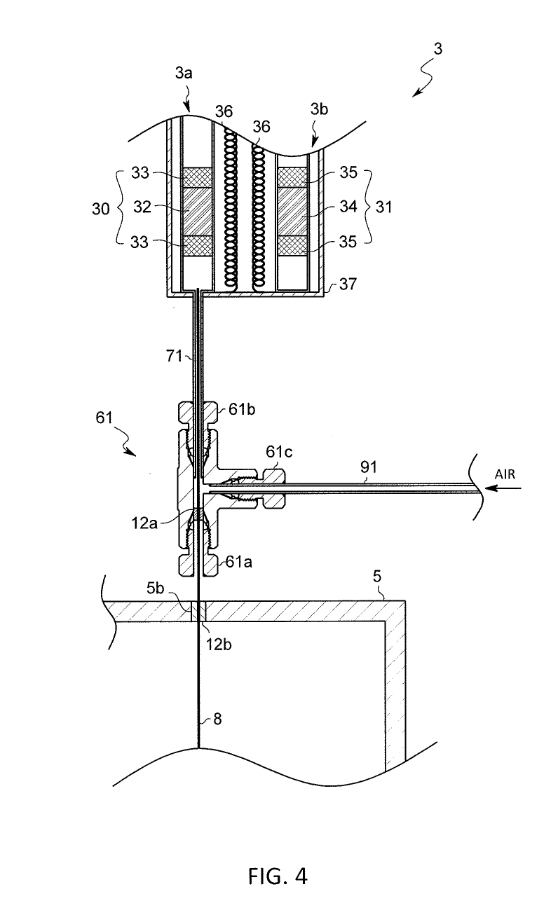

A reaction apparatus in the third embodiment is, as illustrated in FIG. 4, a variation of the above-described reaction apparatus in the first embodiment, and different mainly in configurations of a connecting part 61 and protruding pipe 71; however, parts other than matters described below are the same as those in the first embodiment, and therefore description thereof is omitted.

In the present embodiment, the downstream side end of the column 8 passes through the sample lead-out port 5b and extends outside the thermostatic chamber 5, and further passes through first and second joints 61a and 61b of the connecting part 61 and the protruding pipe 71 and extends to the oxidation reaction pipe 30. Also, the through-hole as the sample lead-out port 5b is filled with a heat insulating material 12b such as glass wool except for a part where the column 8 is arranged.

The connecting part 61 is a three-way joint that is arranged outside the thermostatic chamber 5 and has a T-shape. Inside the mutually opposite first and second joints 61a and 61b among the three joints 61a, 61b, and 61c, the column 8 arranged outside the thermostatic chamber 5 penetrates, and the inside of the first joint 61a on the upstream side of the column 8 is sealed with a sealing member 12a so as to surround the column 8, whereas the second joint 61b on the downstream side of the column 8 is removably fitted with the protruding pipe 71. The third joint 61c disposed between the first joint 61a and the second joint 61b is removably fitted with a first supply pipe 91 for supplying air to the oxidation reaction pipe 30.

The protruding pipe 71 is arranged outside the thermostatic chamber 5, and provided by machining such as welding, or the like, so as to integrally protrude from the oxidation reaction pipe 30, and a fore end thereof is removably fitted to the second joint 61b of the connecting part 61.

Note that the oxidation reaction pipe 30 is, as in the second embodiment, contained in the casing 37 together with the reduction reaction pipe 31 and the heaters 36, the casing 37 is disposed separately from the thermostatic chamber 5, and the oxidation reaction pipe 30 and the thermostatic chamber 5 are connected to each other through the protruding pipe 71 provided so as to protrude from the upstream side end surface of the oxidation reaction pipe 30, the connecting part 61, and the column 8 extending from the sample lead-out port 5b of the thermostatic chamber 5.

Even in the third embodiment, the oxidation reaction pipe 30 and the second joint 61b of the connecting part 61 are separately disposed, and therefore a problem that heat generated by heat treatment of the oxidation reaction pipe 30 adversely influences the second joint 61b can be prevented.

Further, an inside diameter of the protruding pipe 71 is small as compared with the inside diameter of the oxidation reaction pipe 30, and the connecting part 61 arranged on the upstream side of the protruding pipe 71 is supplied with the reaction gas, so that because a flow velocity of the reaction gas is increased while the reaction gas is passing through the protruding pipe 71, the reaction gas can prevent the sample gas mixed with the reaction gas from diffusing or flowing back, and therefore accurate detection can be performed.

A control device in a fourth embodiment of the present invention is described below with reference to drawings.

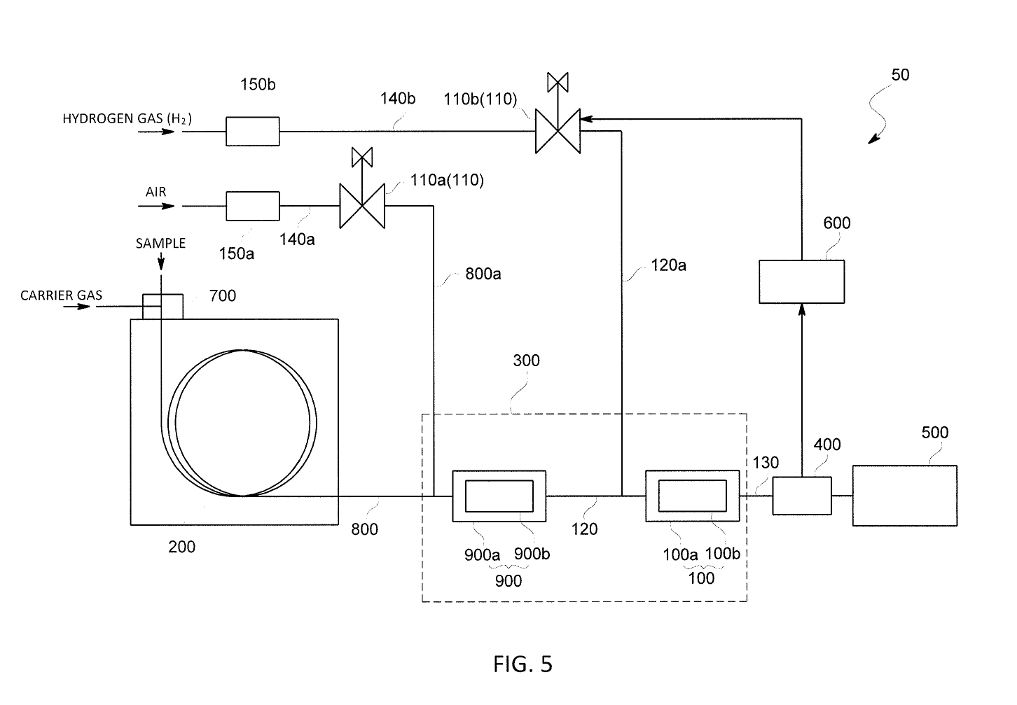

The control device 50 in the present embodiment is, as illustrated in FIG. 5, provided with: a reaction part 300 that is introduced with sample gas having passed through a column 200 and reaction gas of which a flow rate is regulated by a flow rate regulating valve 110, and mixes and reacts the gases to produce measurement gas containing a predetermined compound; a detector 500 that detects the predetermined compound contained in the measurement gas; a flowmeter 400 that is provided on a downstream side of the reaction part 300 and measures a flow rate of the measurement gas to be introduced into the detector 500; and a control part 600 that controls the flow rate regulating valve 110 so as to make constant the flow rate of the measurement gas measured by the flowmeter 400.

The column 200 is a capillary column of which an inner wall is coated with a stationary phase, and an upstream side end thereof is connected to a sample introduction port 700 for introducing carrier gas and a measurement sample, whereas the downstream side other end is connected to a sample gas lead-out path 800 through which the sample gas having passed through the column 200 is led out.

As the stationary phase, a publicly known phase can be appropriately used depending on the type of a sample. Also, as the carrier gas, for example, inert gas such as helium or argon, hydrogen gas, air, or the like can be used.

In addition, in the case where the measurement sample is gas, the measurement sample is directly introduced into the sample introduction port 700; however, in the case where the measurement sample is liquid, the measurement sample is heated and vaporized in an unillustrated vaporizing chamber, and then introduced into the sample introduction port 700.

The reaction part 300 has an oxidation reaction part 900 and reduction reaction part 100 that, as a result of a redox reaction, produce the measurement gas containing the predetermined compound such as methane.

The oxidation reaction part 900 has: an oxidation reaction pipe 900a inside which a metal catalyst such as palladium is arranged; and an oxidation reactor 900b for heating the oxidation reaction pipe 900a, such as a heater.

Regarding the oxidation reaction pipe 900a, an upstream side end thereof is connected to the sample gas lead-out path 800, whereas the downstream side other end is connected to a connecting pipe 120.

Note that the sample gas lead-out path 800 is provided with a branch path 800a, and the branch path 800a is connected to a first supply path 140a for supplying air as the reaction gas to the oxidation reaction part 900 through a first flow rate regulating valve 110a.

The first flow rate regulating valve 110a is arranged between the first supply path 140a and the branch path 800a, and provided with: a first regulating valve main body (not illustrated) that is arranged in the first supply path 140a so as to block a gap between the first supply path 140a and the branch path 800a; and a first drive part (not illustrated) that is externally attached to the first supply path 140a and moves the first regulating valve main body according to a control signal to open/close a path from the first supply path 140a to the branch path 800a.

The first supply path 140a is provided with a mass flowmeter 150a for measuring a flow rate of the air passing through the first supply path 140a. The mass flowmeter 150a is, for example, a thermal type one that measures the flow rate of the fluid with use of a temperature difference that is generated between two pairs of heating resistance wires by flowing the fluid through the first supply path 140a in a state where the two pairs of heating resistance wires are wound around the first supply path 140a to form a bridge circuit and current is flowed through the heating resistance wires to heat the heating resistance wires.

The reduction reaction part 100 has: a reduction reaction pipe 100a inside which a metal catalyst such as nickel is arranged; and a reduction reactor 100b for heating the reduction reaction pipe 100a, such as a heater.

Regarding the reduction reaction pipe 100a, an upstream side end thereof is connected to the connecting pipe 120, whereas the downstream side other end is connected to a measurement gas lead-out path 130.

Note that the connecting pipe 120 is also provided with a branch path 120a, and the branch path 120a is connected to a second supply path 140b for supplying hydrogen gas as the reaction gas to the reduction reaction part 100 through a second flow rate regulating valve 110b.

The second flow rate regulating valve 110b is arranged between the second supply path 140b and the branch path 120a, and provided with: a second regulating valve main body (not illustrated) that is arranged in the second supply path 140b so as to block a gap between the second supply path 140b and the branch path 120a; and a second drive part (not illustrated) that is externally attached to the second supply path 140b and moves the second regulating valve main body according to an after-mentioned drive signal to open/close a path from the second supply path 140b to the branch path 120a.

The second supply path 140b is provided with a mass flowmeter 150b for measuring a flow rate of the hydrogen gas passing through the second supply path 140b. The mass flowmeter 150b is the same as the mass flowmeter 150a provided in the first supply path 140a, and therefore description thereof is omitted here.

The flowmeter 400 is provided in the measurement gas lead-out path 130, and as the flowmeter 400, a thermal type one may be used in the same manner as that for the above-described mass flowmeter 150a or 150b, or for example, a differential pressure type one that, with a plate partially provided with a hole being arranged in the measurement gas lead-out path 130, measures a pressure difference between pressures on upstream and downstream sides of the plate to measure the flow rate, an ultrasonic type one that is externally attached to the measurement gas lead-out path 130, and simultaneously generates ultrasonic waves from two sensors respectively provided on upstream and downstream sides to measure the flow rate with use of a propagation time difference between received signals, or another type one can be used.

The detector 500 is connected to the measurement gas lead-out path 130, and as the detector 500, for example, a hydrogen flame ionization detector (FID) that detects the predetermined compound by measuring ionization current that is generated by flowing the measurement gas into hydrogen flame, which is combustion flame, to ionize the measurement gas with the hydrogen flame, or another detector is used.

The control part 600 is structurally a so-called computer circuit having a CPU, internal memory, I/O buffer circuit, AD converter, and the like. Also, the control part 600 is one that operates according to a program stored in a predetermined area of the internal memory, and thereby performs information processing to fulfill a function thereof.

Further, the control part 600 calculates a deviation between a measured flow rate value of the measurement gas, which is measured by the flowmeter 400, and a preliminarily inputted target flow rate value, then performs arithmetic processing for an action such as a proportional action, a derivative action, or an integral action on the deviation to generate the drive signal, and inputs the drive signal to the second drive part of the second flow rate regulating valve 110b.

Operation of the control device 50 of the present embodiment is described below.

When the gasified sample is mixed in the carrier gas and introduced from the sample introduction port 700, the sample gas that has taken a passage time depending on the molecular weight of the sample, or the like, to pass through the column 200 is led out to the sample gas lead-out path 800, and the sample gas having passed through the sample gas lead-out path 800 is introduced into the oxidation reaction pipe 900a. Further, the air as the reaction gas for the oxidation reaction part 900 is also, after a flow rate thereof has been measured by the gas flowmeter 150a, introduced into the oxidation reaction pipe 900a through the first supply path 140a, first flow rate regulating valve 110a, branch path 800a, and sample gas lead-out path 800.

The sample gas and air introduced into the oxidation reaction pipe 900a are mixed in the oxidation reaction pipe 900a, and because the oxidation reaction pipe 900a is heated by the oxidation reactor 900b, produce an oxidation reaction to produce oxidation gas such as carbon dioxide. Then, the oxidation gas is introduced into the reduction reaction part 100 through the connecting pipe 120. Further, the hydrogen gas as the reaction gas for the reduction reaction part 100 is also, after a flow rate thereof has been measured by the gas flowmeter 150b, introduced into the reduction reaction pipe 100a through the second supply path 140b, second flow rate regulating valve 110b, branch path 120a, and connecting pipe 120.

The sample gas and hydrogen gas introduced into the reduction reaction pipe 100a are mixed in the reduction reaction pipe 100a, and because the reduction reaction pipe 100a is heated by the reduction reactor 100b, produce a reduction reaction to produce the measurement gas containing the predetermined compound such as methane. Then, the measurement gas passes through the measurement gas lead-out path 130, and is, after a flow rate thereof has been measured by the flowmeter 400, introduced into the detector 500.

The measurement gas introduced into the detector 500 is ionized with hydrogen flame of the detector 500, and by measuring current generated by the ion, the predetermined compound contained in the measurement gas is detected.

In addition, as necessary, the connecting pipe 120 or the measurement gas lead-out path 130 may be provided with a filter for capturing and removing water produced by the oxidation reaction or the reduction reaction.

Next, control performed by the control device 50 of the present embodiment to make the flow rate of the measurement gas constant is described below.

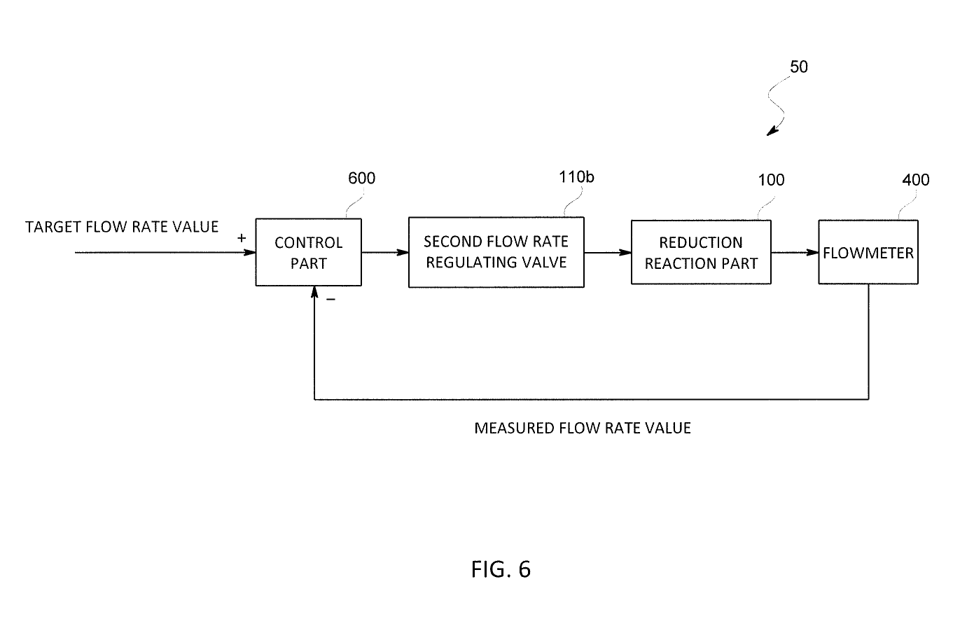

When the measured flow rate value of the measurement gas, which is measured by the flowmeter 400, is inputted to the control part 600, as illustrated in FIG. 6, the control part 600 performs feedback control that calculates the deviation between the preliminarily inputted target flow rate value and the measured flow rate value, then performs the arithmetic processing for an action such as a proportional action or a derivative action on the deviation to generate the drive signal, and inputs the drive signal to the second drive part of the second flow rate regulating valve 110b.

The second drive part moves the second regulating valve main body according to the drive signal to control the flow rate of the hydrogen gas, and the hydrogen gas of which the flow rate is controlled is introduced into the reduction reaction part 100 through the branch path 120a and connecting pipe 120. In the reduction reaction part 100, as described above, the hydrogen gas and the oxidation gas are mixed and heated to produce the measurement gas, which is led out to the measurement gas lead-out path 130. Regarding the measurement gas led out to the measurement gas lead-out path 130, the flow rate thereof is measured by the flowmeter 400.

Further, a series of flowing steps described above is repeated, and thereby the measured flow rate vale measured by the flowmeter 400 becomes constant.

According to the present invention, the flow rate of the reaction gas (in the present embodiment, hydrogen gas) is controlled to make constant the flow rate of the measurement gas to be introduced into the detector 500, and therefore a variation in measurement sensitivity of the detector 500, which occurs in association with a change in shape of the combustion flame, can be prevented to perform accurate detection.

Also, the flow rate of the measurement gas is made constant with use of the reaction gas used to produce the measurement gas, so that it is not necessary to separately provide a pipe or the like only for the purpose of making the flow rate of the measurement gas constant, and therefore the flow rate of the measurement gas can be made constant with cost being suppressed.

In addition, according to the present invention, in the reduction reaction part provided immediately before the measurement by the flowmeter 400, the flow rate of the hydrogen gas is controlled to make the flow rate of the measurement gas constant, and therefore the flow rate of the measurement gas can be more accurately made constant to perform accurate detection.

Also, according to the present invention, the oxidation reaction pipe 900a and the reduction reaction pipe 100a are respectively provided with the metal catalysts in order to facilitate the reactions; however, even in the case where any of the metal catalysts is thermally expanded to vary the flow rate of the measurement gas, the flow rate of the measurement gas, which is varied by the thermal expansion of the metal catalyst, is measured by the flowmeter 400, and the control part 600 uses the measured flow rate value to generate the drive signal, and inputs the drive signal to the second flow rate regulating valve 110, so that the reaction gas (in the present embodiment, hydrogen gas) can be controlled in accordance with the measurement gas flow rate varied by the thermal expansion, and therefore even in the case where the metal catalyst is thermally expanded, accurate detection can be performed.

Further, according to the present invention, as a result of the redox reaction in the oxidation reaction part 900 and reduction reaction part 100, the measurement gas containing the predetermined compound such as methane is produced, and the predetermined compound is detected by the detector 500, so that a reference material to be prepared is only required to be the predetermined compound, and therefore the time and effort required to prepare a reference material for each sample can be saved to simply perform the detection.

Note that the present invention is not limited to the above-described embodiment.

For example, in the above-described embodiment, the hydrogen gas used as the reaction gas for the reduction reaction part 100 is controlled; however, the air used as the reaction gas for the oxidation reaction part 900 may be controlled to make the flow rate of the measurement gas constant. In this case, the control part 600 inputs a generated drive signal to the first drive part of the first flow rate regulating valve 110a to move the first flow rate regulating valve main body, and controls the flow rate of the air so as to make the measured flow rate value of the measurement gas constant.

In addition, both of the air used as the reaction gas for the oxidation reaction part 900, and the hydrogen gas used as the reaction gas for the reduction reaction part 100 can also be controlled to make the flow rate of the measurement gas constant.

Further, in the above-described embodiment, as the detector 500, the hydrogen flame ionization detector is used; however, an alkali flame thermionic detector (FTD), a thermal conductivity detector (TCD), or the like may be used.

Note that the present invention is not limited to any of the above-described embodiments.

In any of the above-described embodiments, as the column, the capillary column is used; however, depending on the type of a sample, or the like, a packed column may be used, which is a pipe made of glass, stainless steel, or the like, inside which a stationary phase is filled.

In any of the above-described embodiments, as the detector, the hydrogen flame ionization detector is used; however, an alkali flame thermionic detector (FTD), a thermal conductivity detector (TCD), or the like may be used.

Also, in any of the above-described embodiments, as the predetermined compound to be detected by the detector, methane produced in the oxidation reaction part and reduction reaction part is used; however, for example, a predetermined compound produced only in the oxidation reaction part, or a predetermined compound produced only in the reduction reaction part may be detected by the detector. In addition, in the case of using only the reduction reaction part to produce the predetermined compound, the protruding pipe is provided so as to protrude from the upstream side end of the reduction reaction pipe.

Further, each of the first supply path and the second supply path may be, in place of the mass flow controller, provided with a flow rate regulating valve for regulating the flow rate of the air or hydrogen gas.

Still further, as the inside diameter of the oxidation reaction pipe, an optimum diameter leading to a flow velocity that enables the oxidation reaction to be produced in the oxidation reaction pipe and prevents the sample gas from flowing back can be appropriately selected with being compared with the inside diameter of the protruding pipe. The inside diameter of the oxidation reaction pipe may be, for example, the same as the inside diameter of the protruding part.

The present invention can be variously modified unless contrary to the scope thereof.

### REFERENCE SIGNS LIST

1 . . . Reaction apparatus
3 . . . Reaction part
6, 60, 61 . . . Connecting part
7, 70, 71 . . . Protruding pipe
8 . . . Column
9 . . . First supply path
10 . . . Second supply path
30 . . . Oxidation reaction pipe
31 . . . Reduction reaction pipe

1. A reaction apparatus comprising:
a reaction part that is introduced with sample gas having passed through a column and reaction gas, and as a result of a reaction between the sample gas and the reaction gas, produces measurement gas containing a predetermined compound;
a protruding pipe that is integrally protruded from the reaction part; and
a connecting part that is disposed separately from the reaction part and removably fitted with the protruding pipe.

2. The reaction apparatus according to claim 1, wherein:
the connecting part is provided with a supply path for supplying the reaction gas;
the reaction part has a reaction pipe having one end surface from which the protruding pipe integrally protrudes; and
an inside diameter of the protruding pipe is equal to or less than an inside diameter of the reaction pipe.

3. The reaction apparatus according to claim 1, wherein:
the column extending to the reaction pipe passes through the protruding pipe;
the reaction gas passes through a gap between the column and the protruding pipe; and
the sample gas having passed through the column and the reaction gas are mixed in the reaction pipe.

4. The reaction apparatus according to claim 1, further comprising
a thermostatic chamber of which an inside is arranged with the column and the connecting part and a surface is formed with a through-hole, wherein
the protruding pipe is inserted into the thermostatic chamber through the through-hole, and the reaction part is placed on the surface of the thermostatic chamber.

5. The reaction apparatus according to claim 2, wherein:
the connecting part is a three-way joint that is provided with a first joint, a second joint, and a third joint disposed between the first joint and the second joint; and
the column passes through the first joint and the second joint, the second joint arranged on a downstream side of the column is removably fitted with the protruding pipe, and the third joint is fitted with the supply path.

6. A control device comprising:
a reaction part that is introduced with sample gas having passed through a column and reaction gas of which a flow rate is regulated by a flow rate regulating valve, and as a result of a reaction between the sample gas and the reaction gas, produces measurement gas containing a predetermined compound;
a flowmeter that is provided on a downstream side of the reaction part and measures a flow rate of the measurement gas to be introduced into a detector for detecting the predetermined compound; and
a control part that controls the flow rate regulating valve such that the flow rate of the measurement gas becomes a predetermined value, the flow rate being measured by the flowmeter.

7. The control device according to claim 6, wherein
the control part performs arithmetic processing on a deviation between a measured flow rate value of the measurement gas, the measured flow rate value being measured by the flowmeter, and a predetermined target flow rate value to generate a drive signal, and uses the drive signal to control the flow rate regulating valve.

8. The control device according to claim 6, wherein
the reaction part is provided with a metal catalyst.

9. The control device according to claim 6, wherein:
the reaction part has
an oxidation reaction part that is introduced with the sample gas and air of which a flow rate is regulated by a first flow rate regulating valve, and mixes the sample gas and the air to produce oxidation gas as a result of an oxidation reaction, and
a reduction reaction part that is introduced with the oxidation gas and hydrogen gas of which a flow rate is regulated by a second flow rate regulating valve, and as a result of a reduction reaction between the oxidation gas and the hydrogen gas, produces the measurement gas containing the predetermined compound;
the flowmeter is provided on a downstream side of the reduction reaction part; and
the control part uses the drive signal to control the second flow rate regulating valve.

10. The control device according to claim 6, wherein
the detector is a hydrogen flame ionization detector.

11. A control program having; a reaction part that is introduced with sample gas having passed through a column and reaction gas of which a flow rate is regulated by a flow rate regulating valve, and as a result of a reaction between the sample gas and the reaction gas, produces measurement gas containing a predetermined compound; a flowmeter that is provided on a downstream side of the reaction part and measures a flow rate of the measurement gas to be introduced into a detector for detecting the predetermined compound; and a control part that controls the flow rate regulating valve such that the flow rate of the measurement gas becomes a predetermined value, the flow rate being measured by the flowmeter,
the control program instructing a computer to perform a feedback step of performing arithmetic processing on a deviation between a measured flow rate value of the measurement gas, the measured flow rate value being measured by the flowmeter, and a predetermined target flow rate value, and feeding a drive signal generated by the arithmetic processing back to the flow rate regulating valve.
